(19) United States
(12) Patent Application Publication
(10) Pub. No.: US 2025/0340309 A1
(43) Pub. Date: Nov. 6, 2025

(54) LIFT FOR AN AIRPLANE

(71) Applicant: Doug J. Schumacher, Laconia, NH (US)

(72) Inventor: Doug J. Schumacher, Laconia, NH (US)

(21) Appl. No.: 19/197,381

(22) Filed: May 2, 2025

Related U.S. Application Data
(60) Provisional application No. 63/642,442, filed on May 3, 2024.

(51) Int. Cl. B64F 3/00

(52) U.S. Cl. CPC B64F 3/00

(57) ABSTRACT

An airplane lift including: a base configured to be supported on a support surface; a vertical support assembly coupled to the base, the vertical support assembly movable between a contracted position and an extended position; a platform removably couplable to the vertical support assembly and configured to support an airplane; and a drive mechanism supported by the base and configured to move the platform between a loading position and a storage position, wherein a maximum height of the vertical support assembly is less than or equal to 9 feet when in the contracted position, such that the airplane lift may be transported with the vertical support assembly pre-assembled and in the contracted position.

### CROSS-REFERENCE TO RELATED APPLICATIONS

This application is a non-provisional of and claims the benefit of U.S. Provisional Patent Application No. 63/642,442, filed on May 3, 2024, the entire contents of which are incorporated herein by reference.

### FIELD OF THE INVENTION

The present invention relates to a lift for an airplane.

### SUMMARY OF THE INVENTION

In some aspects, the techniques described herein relate to an airplane lift including: a base configured to be supported on a support surface; a vertical support assembly coupled to the base, the vertical support assembly movable between a contracted position and an extended position; a platform removably couplable to the vertical support assembly and configured to support an airplane; and a drive mechanism supported by the base and configured to move the platform between a loading position and a storage position, wherein a maximum height of the vertical support assembly is less than or equal to 9 feet when in the contracted position, such that the airplane lift may be transported with the vertical support assembly pre-assembled and in the contracted position.

In some aspects, the techniques described herein relate to an airplane lift including: a base configured to be supported on a support surface; a drive mechanism supported by the base; a first vertical support member supported by the base; a second vertical support member pivotably coupled to the first vertical support member; a bracket fixedly coupled to the drive mechanism; and a platform removably couplable to the bracket and configured to support an airplane, wherein in a contracted position, the second vertical support member is positioned at an oblique angle relative to the first vertical support member, such that the first vertical support member defines a maximum height of the airplane lift that is 9 feet or less, wherein the airplane lift may be transported with the second vertical support member pre-assembled with the first vertical support member and in the contracted position, wherein in an extended position, the second vertical support member is supported by and aligned with the first vertical support member such that the first vertical support member and the second vertical support member collectively define a maximum height of the airplane lift that is greater than 9 feet, and wherein in the extended position, the bracket is movable along the first vertical support member and the second vertical support member to move the platform between a loading position and a storage position.

In some aspects, the techniques described herein relate to an airplane lift including: a base configured to be supported on a support surface; a vertical support assembly supported by the base, the vertical support assembly movable between a contracted position and an extended position; a platform removably couplable to the vertical support assembly and including at least one wheel support configured to support an airplane, the at least one wheel support including a wheel restraint and a sensor associated with the wheel restraint; a drive mechanism supported by the base and configured to move the platform between a loading position and a storage position; an electronic control unit in electrical communication with an actuator of the drive mechanism and the sensor of the at least one wheel support; wherein a height of the vertical support assembly is less than or equal to 9 feet when in the contracted position, such that the airplane lift may be transported already assembled in the contracted position, wherein the sensor of the at least one wheel support is configured to send a signal to the electronic control unit when the wheel restraint is secured to the wheel support, and wherein the electronic control unit is configured to allow the drive mechanism to be actuated when the actuator is actuated when the sensor of the at least one wheel support sends the signal to electronic control unit, and prevent the drive mechanism from being actuated when the actuator is actuated when the sensor of the at least one wheel support does not send the signal to electronic control unit.

In some aspects, the techniques described herein relate to a method for transporting a lift including a base configured to be supported on a support surface, a vertical support assembly supported by the base, a platform removably couplable to the vertical support assembly and configured to support an airplane, and a drive mechanism supported by the base and configured to move the platform between a loading position and a storage position, the method including: assembling the base, the vertical support assembly, and the drive mechanism into a contracted position in which the vertical support assembly defines a height of 9 feet or less; providing the platform disassembled from the vertical support assembly; and transporting the platform and the assembled base, the vertical support assembly, and the drive mechanism in the contracted position.

Other features and aspects of the invention will become apparent by consideration of the following detailed description and accompanying drawings.

### BRIEF DESCRIPTION OF THE DRAWINGS

FIG. 1 is a perspective view of a lift for an airplane in accordance with an embodiment of the invention, the lift includes a vertical support assembly in a contracted position, horizontal support members in an extended position, and a platform in an extended position for supporting the airplane.

FIG. 2 is a perspective view of the lift of FIG. 1 accommodating two airplanes.

FIG. 3 is a side view of the lift of FIG. 1 accommodating two airplanes.

FIG. 4 is a front view of the lift of FIG. 1 accommodating two airplanes.

FIG. 5 is a perspective view of the lift of FIG. 1 with the vertical support assembly in the contracted position, the horizontal support members in the extended position, and with the platform for supporting the airplane in the extended position.

FIG. 6 is a perspective view of the lift of FIG. 1 with the vertical support assembly in the contracted position, the platform detached from the vertical support assembly, and the horizontal support members in a contracted position.

FIG. 7 is a top view of the lift of FIG. 1 the vertical support assembly in the contracted position, the platform detached from the vertical support assembly, and the horizontal support members in the contracted position.

FIG. 8 is a side view of the lift of FIG. 1 the vertical support assembly in the contracted position, the platform detached from the vertical support assembly, and the horizontal support members in the contracted position.

FIG. 9 is a perspective view of the platform in a contracted position.

FIG. 10 is a perspective view of the vertical support assembly of the lift of FIG. 1 in the extended position.

FIG. 11 is a detailed perspective view of a portion of the vertical support assembly of the lift of FIG. 1 in the contracted position.

FIG. 12 is a detailed perspective view of the vertical support assembly of the lift of FIG. 1 with a portion removed.

FIG. 13 is a perspective view of a lift for an airplane in accordance with another embodiment of the invention, the lift includes a vertical support assembly in an extended position, horizontal support members in an extended position, and a platform in an extended position for supporting the airplane.

FIG. 14 is a perspective view of the lift of FIG. 13 accommodating two airplanes.

FIG. 15 is a side view of the lift of FIG. 13 accommodating two airplanes.

FIG. 16 is a front view of the lift of FIG. 13 accommodating two airplanes.

FIG. 17 is a perspective view of the lift of FIG. 13 with the vertical support assembly in the contracted position, the platform detached from the vertical support assembly, and the horizontal support members in a contracted position.

FIG. 18 is a top view of the lift of FIG. 13 the vertical support assembly in the contracted position, the platform detached from the vertical support assembly, and the horizontal support members in the contracted position.

FIG. 19 is a side view of the lift of FIG. 13 the vertical support assembly in the contracted position, the platform detached from the vertical support assembly, and the horizontal support members in the contracted position.

FIG. 20 is a side view of the lift of FIG. 13 with the vertical support assembly moving from the contracted position to the extended position.

FIG. 21 is a detailed perspective view of the vertical support assembly of the lift of FIG. 13 showing the installation of fasteners (e.g., bolts).

FIG. 22 is another detailed perspective view of the vertical support assembly of the lift of FIG. 13 showing removal of a linkage.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

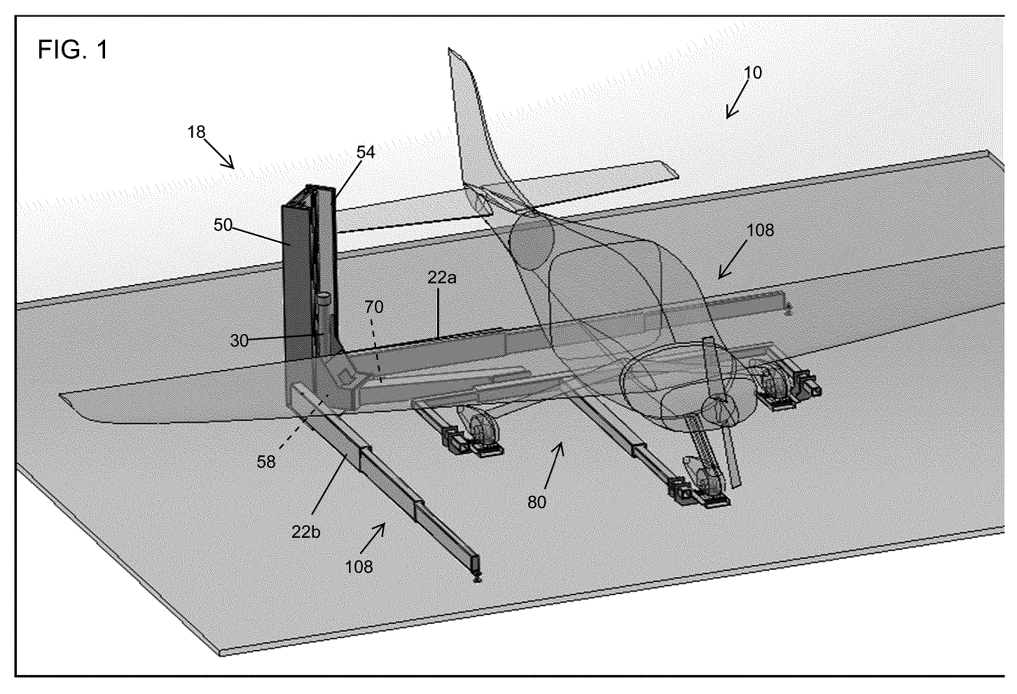

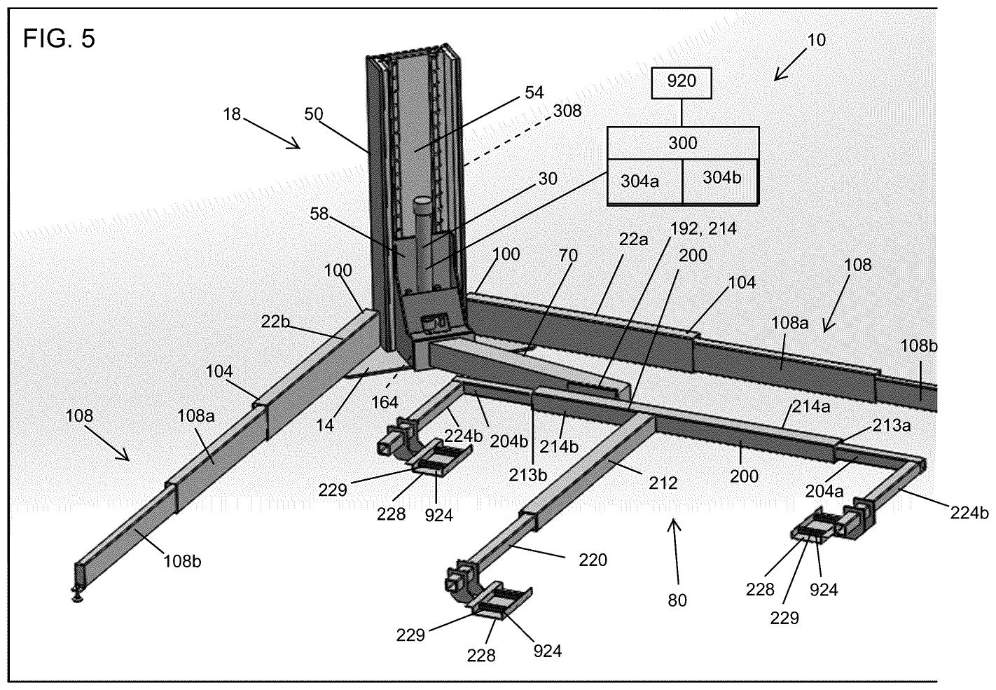

With reference to FIGS. 1-5, a lift 10 according to one embodiment is illustrated. With respect to FIGS. 1 and 5, the lift 10 includes a base 14 supported by a support surface, a vertical support assembly 18 supported by the base 14, a first horizontal support member 22a supported by the base 14, a second horizontal support member 22b supported by the base 14 (FIG. 5), and a drive mechanism 30 supported by the base 14. In the illustrated embodiment, the drive mechanism 30 is a hydraulic cylinder. The vertical support assembly 18 includes a vertical support member 50 supported by the base 14, a telescopic member 54 movably coupled to the vertical support member 50, and a bracket 58 movably coupled to the telescopic member 54. The lift 10 further includes an arm 70 removably coupled to and movable with the bracket 58 and a platform 80 removably coupled to the arm 70 and configured to support an airplane.

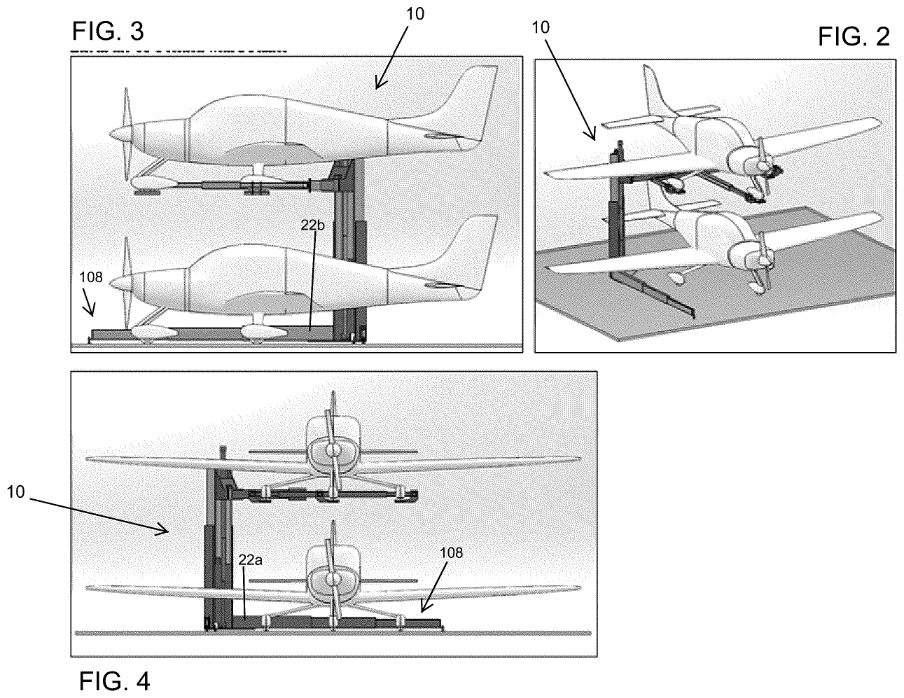

As will be discussed in greater detail below, the hydraulic cylinder 30 is configured to move the platform 80 between a loading position (FIG. 1) and a storage position (FIGS. 2-4). In the loading position, the platform 80 is supported on or adjacent to the support surface such that a first airplane can be loaded or unloaded from the platform 80. In the storage position, the platform 80 is supported above the support surface such that the first airplane is supported by the platform 80 above the support surface. When the platform 80 is in the storage position, a second airplane can be stored within the lift 10 below the first airplane. The platform 80 is movable between the loading position and the storage position because the bracket 58, and therefore the arm 70, are movable along the telescopic member 54 and the telescopic member 54 is movable along the vertical support member 50. The platform 80 is also movable to one or more intermediate positions in which the platform 80 is supported above the support surface by a height that is less than a height of the platform 80 in the storage position. The intermediate positions of the platform 80 may also be storage positions.

As will be discussed in greater detail below, the lift 10 is configured such that the base 14, the vertical support assembly 18, the arm 70, the first horizontal support member 22a, the second horizontal support member 22b, and the hydraulic cylinder 30 are assembled and transported (e.g., shipped, driven, or otherwise transported) after being assembled. Accordingly, once assembled, the base 14, the vertical support assembly 18, the arm 70, the first horizontal support member 22a, the second horizontal support member 22b, and the hydraulic cylinder 30 collectively have a maximum height of 9 feet and a maximum width of 8 feet. Moreover, once assembled, the base 14, the vertical support assembly 18, the arm 70, the first horizontal support member 22a, the second horizontal support member 22b, and the hydraulic cylinder 30 collectively may be contained within a volume equal to or less than 720 ft³. That is, for example, the base 14, the vertical support assembly 18, the first horizontal support member 22a, the second horizontal support member 22b, and the hydraulic cylinder 30 are configured to fit into a trailer or container of a semi-truck (e.g., tractor trailer). The smaller portions of the lift that are disassembled from the vertical support assembly, such as the platform 80, are also sized to fit into the semi-truck. Accordingly, the entire lift can be transported easily to its destination. Further, when an operator receives the lift 10, the base 14, the vertical support assembly 18, the arm 70, the first horizontal support member 22a, the second horizontal support member 22b, and the hydraulic cylinder 30 pre-assembled, and the operator need only couple the platform 80 to the arm 70 and lengthen the horizontal support members 22a, 22b. This configuration greatly reduces the time and cost of delivery and assembly of the lift 10, since the assembly required once delivered is minimal. Minimal assembly reduces the risk of improper assembly and reduces safety hazards during assembly which in turn reduce liability risks for the manufacturer. That is, the configurations discussed herein avoids the need for rigging for assembly using heavy equipment (e.g., fork trucks, lifts, cranes, etc.) and the need for skilled heavy machinery assemblers (e.g., riggers, millwrights, mechanics, etc.) at the operator's location since the major components (e.g., the base 14, 414, the vertical support assembly 18, 418, the first horizontal support member 22a, 422a, the second horizontal support member 22b, 422b, and the hydraulic cylinder 30, 430, etc.) are all pre-assembled.

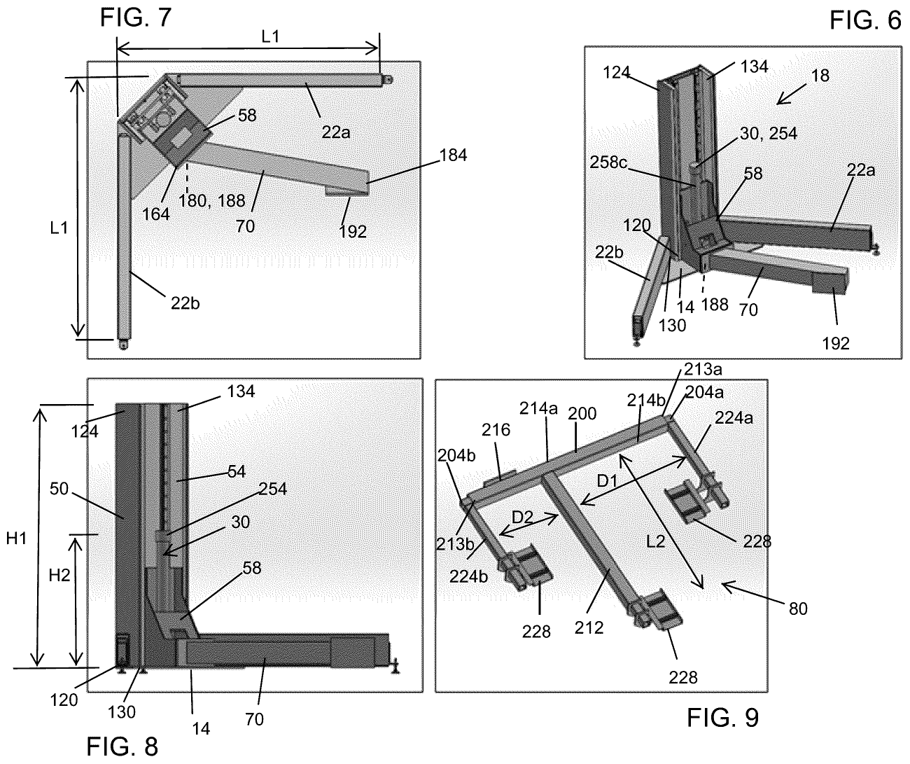

With respect to FIG. 5, the first horizontal support member 22a and the second horizontal support member 22b each include a first end 100 coupled to the base 14 and a second end 104 opposite the first end 100. With respect to FIG. 7, each of the first horizontal support member 22a and the second horizontal support member 22b each include a length L1 that is less than or equal to 8 feet. In the illustrated embodiment, each of the first horizontal support member 22a and the second horizontal support member 22b are configured to couple to an extension 108 that increases the length of the same when in an extended position (FIGS. 1-5). The extension 108 may be configured to couple to the respective first and second horizontal support members 22a, 22b once the lift 10 is delivered and may be coupled in any suitable way. For example, the extensions 108 may be coupled to the horizontal support members 22a, 22b via fasteners (e.g., a bolts), pins, a snap fit engagement, or a detent mechanism. In the illustrated embodiment, the extensions 108 are telescopic and therefore include a first extension member 108a configured to couple to the respective horizontal support member 22a, 22b and a second extension member 108b configured to telescope towards and away from the first extension member 108a. In other embodiments, the extensions 108 may be a single member with a uniform length. In other embodiments, the telescopic extensions 108 may be coupled to the horizontal support members 22a, 22b before transport and maintained in a contracted position (e.g., FIGS. 6 and 7) for transport. Regardless, the extensions 108 increase the length of the horizontal support members to be greater than L1. Accordingly, the extensions, once assembled and/or extended to achieve the extended position after delivery, offer greater support to the lift 10. In the illustrated embodiment, the horizontal support members 22a, 22b are not movable relative to the base 14. In other embodiments, the horizontal support members 22a, 22b may be pivotable relative to the base 14 and each other, such that they are closer together in the transport position of the lift 10.

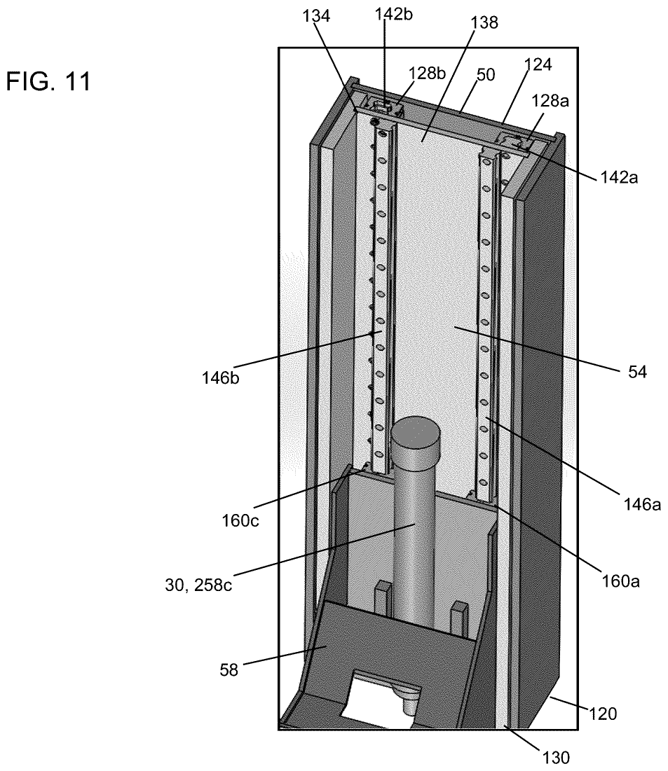

With respect to FIG. 8, the vertical support member 50 includes a first end 120 coupled to the base 14 and a second end 124 opposite the first end 120. The vertical support member 50 includes a first height H1 that is less than or equal to 9 feet. With respect to FIG. 11, the vertical support member 50 includes a plurality of bearings 128. For example, the vertical support member 50 may include at least a first bearing 128a and a second bearing 128b. In other examples, the vertical support member 50 may include a single bearing or greater than two bearings. In the illustrated embodiment, the bearings 128a, 128b are linear ball bearings. In other embodiments, the bearings 128a, 128b may include other types of linear bearings, roller bearings, track wheels or any other suitable bearings.

The telescopic member 54 includes a first end 130 and a second end 134 opposite the first end 130. With respect to FIG. 11, the telescopic member 54 includes a wall 138 that extends between the first end 130 and the second end 134. The wall 138 includes an inner surface that faces a wall of the vertical support member 50 and an outer surface that is opposite the inner surface. The telescopic member 54 includes a first inner track 142a and a second inner track 142b, each of which extends from the inner surface. The first inner track 142a is configured to be received in and movable within the first bearing 128a of the vertical support member 50. The second inner track 142b is configured to be received in and movable within the second bearing 128b. Accordingly, the telescopic member 54 is configured to be coupled to the vertical support member 50 and vertically movable along the vertical support member 50 between the first end 120 and the second end 124. In the illustrated embodiment, the balls (not shown) of the linear ball bearings 128a, 128b are configured to maintain pressure on opposite surfaces of the respective track 142a, 142b as the telescopic member 54 moves vertically along the vertical support member 50 between the first end 120 and the second end 124. The telescopic member 54 also includes a first outer track 146a and a second outer track 146b, each of which extends from the outer surface.

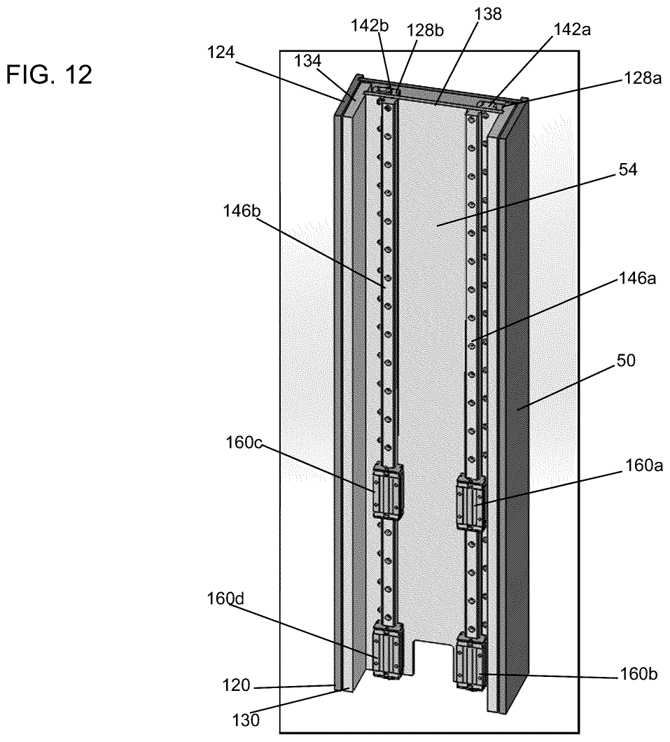

The bracket 58 is movably coupled to the telescopic member 54. The bracket 58, like the vertical support member 50, includes a plurality of bearings 160a-160d (FIG. 12). For example, the bracket 58 may include a first bearing 160a, a second bearing 160b, a third bearing 160c, and a fourth bearing 160d. In other examples, the bracket 58 may include a single bearing or greater than four bearings. In the illustrated embodiment, the bearings 160a-160d are linear ball bearings. In other embodiments, the bearings 160a-160d may include other types of linear bearings, roller bearings, track wheels or any other suitable bearings. The first and second bearings 160a, 160b are a first pair of bearings that are configured to receive the first outer track 146a and the third and fourth bearings 160c, 160d are a second pair of bearings that are configured to receive the second outer track 146b. The first pair of bearings 160a, 160b are configured to move along the first outer track 146a, and the second pair of bearings 160c, 160d are configured to move along the second outer track 146b. Accordingly, the bracket 58 is configured to be coupled to the telescopic member 54 and vertically movable along the telescopic member 54 between the first end 130 and the second end 134. In the illustrated embodiment, the balls (not shown) of the linear ball bearings 160a-160d are configured to maintain pressure on opposite surfaces of the respective track 146a, 146b as the bracket 58 moves vertically along the telescopic member 54 between the first end 130 and the second end 134. The bracket 58 also has a coupling face 164. The hydraulic cylinder 30 is coupled to the bracket 58, such that the bracket 58 is movable with the hydraulic cylinder 30.

The arm 70 includes a first end 180 and a second end 184. The first end includes a first coupling face 188 that is configured to couple to the coupling face 164 of the bracket 58. The arm 70 also has a second coupling face 192 that is at or adjacent to the second end 184. The arm 70 is configured to be coupled to the bracket 58 in a first orientation (shown in the figures) in which the arm 70 is generally closer to the first horizontal support member 22a than to the second horizontal support member 22b or a second orientation in which the arm 70 is generally closer to the second horizontal support member 22b than to the first horizontal support member 22a. In the first orientation, lift 10 is therefore configurable as a left-handed hanger, and in the second orientation, the lift 10 is therefore configurable as a right-handed hanger.

The platform 80 includes a central support member 200, a first telescopic support member 204a removably couplable to the central support member 200, and a second telescopic support member 204b removably couplable to the central support member 200 (FIG. 5). The central support member 200 is a T-shape and defines a first arm 212. The central support member 200 includes a first end 213a, a second end 213b, first surface 214a and a second surface opposite the first surface 214b. The first surface 214a includes a coupling face 216 that is configured to be coupled to the second coupling face 192 of the arm 70. The first arm 212 extends from the second surface 214b. In the illustrated embodiment, a third telescopic support member 220 is removably couplable to the first arm 212. The first telescopic support member 204a is an L-shape and defines a second arm 224a, and the second telescopic support member 204b is an L-shape and defines a third arm 224b. The first telescopic support member 204a is configured to couple to the central support member 200 to extend from the first end 213a of the central support member 200. The second telescopic support member 204b is configured to be coupled to the central support member 200 and to extend from the second end 213b of the central support member 200. Accordingly, the second and third arms 224a, 224b are parallel to and on opposite sides of the first arm 212. Although not shown, another telescopic support member may be removably couplable to each of the second and third arms 224a, 224b to adjust the length thereof. The first telescopic support member 204a is configured to be horizontally movable towards and away from the first end 213a of the central support member 200. The first telescopic support member 204a can be coupled in a plurality of positions such that a distance D1 between the first arm 212 and the second arm 224a can be adjusted. The second telescopic support member 204b is configured to be horizontally movable towards and away from the second end 213b of the central support member 200. The second telescopic support member 204b can be coupled in a plurality of positions such that a distance D2 between the first arm 212 and the third arm 224b can be adjusted. Similarly, the third telescopic support member 220 is configured to be coupled to the first arm 212 in a plurality of positions such that a length L2 of the first arm 212 may be adjusted. Each of the arms 220, 224a, 224b includes a wheel support member 228 configured to support one of a plurality of wheels of the airplane. The wheel support members 228 each include one or more wheel chocks 229 configured to and prevent the plane from rolling off the platform 80.

As shown in FIGS. 1-4, the platform 80 is configured to support a tricycle gear airplane, which has three wheels including a front wheel generally under the nose and two wheels under the wings. The wheel support member 228 of the first arm 220 supports the front wheel, while the wheel support members 228 of the second and third arms 224a, 224b each support one of the wheels under the wings. The distances D1, D2 and the length L2 are adjustable such that the platform 80 is movable from a contracted position (FIG. 9) to one or more extended positions (e.g., FIGS. 1 and 5). Accordingly, the platform 80 can accommodate airplanes with various wheel locations. The platform 80 illustrated herein is merely exemplary and may have other configurations for other types of airplanes (e.g., a tail dragger airplane or a seaplane). For example, in other embodiments, the platform 80 may be configured to support a tail dragger airplane, which has three wheels including a rear wheel generally under the tail and two wheels generally under the wings. In such case, the first arm 212 may extend from first surface 214a of the central support member 200. The first arm 212 and the third telescopic support member 220 therefore extend from the central support member 200 in a direction opposite that of the second and third arms 224a, 224b. When configured this way the wheel support member 228 of the first arm 220 supports the rear wheel, while the wheel support members 228 of the second and third arms 224a, 224b each support one of the wheels beneath the wings.

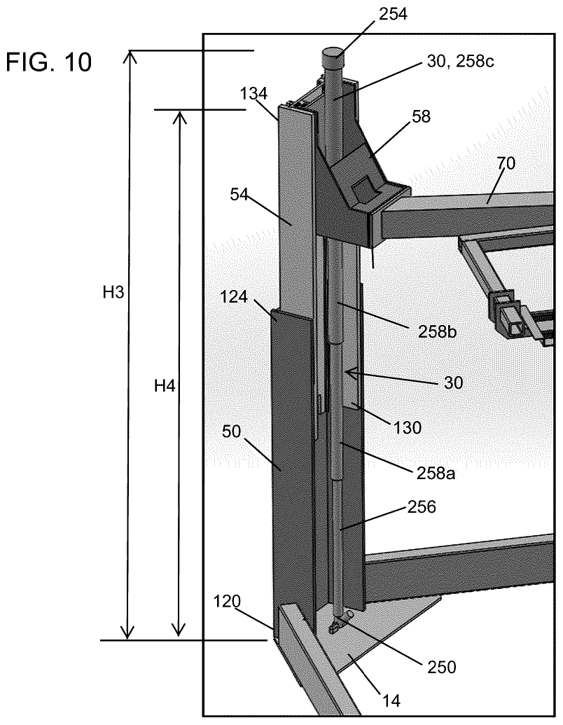

The hydraulic cylinder 30 is a telescopic hydraulic cylinder and includes a first end 250 coupled to the base 14 and a second end 254 opposite the first end 250 (FIG. 10). The telescopic hydraulic cylinder 30 includes a piston 256 and a plurality of cylinders 258a-258c. In the illustrated embodiment, the plurality of cylinders includes a first cylinder 258a, a second cylinder 258b, and a third cylinder 258c. The piston 256 is movably received within the first cylinder 258a. The first cylinder 258a is movably received within the second cylinder 258b. The second cylinder 258b is movably received within the third cylinder 258c. The piston 256 includes a first end and a second end opposite the first end. The first end of the piston 256 is the first end 250 of the telescopic hydraulic cylinder 30 and is coupled to the base 14. The second end of the piston 256 is positioned and movable within the first cylinder 258a. The first cylinder 258a includes a first end and a second end opposite the first end. The second end of the first cylinder 258a is positioned and movable within the second cylinder 258b. The second cylinder 258b includes a first end and a second end opposite the first end. The second end of the second cylinder 258b is positioned and movable within the third cylinder 258c. The third cylinder 258c includes a first end and a second end opposite the first end. The second end of the third cylinder 258c is the second end 254 of the telescopic hydraulic cylinder 30. The third cylinder 258c is coupled to and movable with the bracket 58. In other embodiments, the hydraulic cylinder 30 may include greater or fewer than three cylinders 258a-258c.

A hydraulic pump 300 is operably coupled to the telescopic hydraulic cylinder 30 and is configured to move the telescopic hydraulic cylinder 30 between a first position (e.g., a retracted position, FIG. 1), a second position (e.g., an extended position, FIGS. 2-4), and one or more intermediate positions, as will be discussed in greater detail below. The bracket 58, and therefore the arm 70, and the telescopic member 54 are movable with the hydraulic cylinder 30 to the first position, the second position, and the intermediate positions to move the platform 80 between the loading position, the storage position, or the one or more intermediate positions. The hydraulic pump 300 includes a first actuator 304a (e.g., an up actuator) and a second actuator 304b (e.g., a down actuator). When the operator actuates the first actuator 304a, the hydraulic pump 300 extends the hydraulic cylinder 30, which moves the bracket 58, the arm 70, and the platform 80 from the first position or an intermediate position to a higher position. When the operator actuates the second actuator 304b, the hydraulic pump 300 retracts the hydraulic cylinder 30, which moves the bracket 58, the arm 70, and the platform 80 from the second position or an intermediate position to a lower position.

The vertical support assembly 18 also has a lock 308 that is configured to selectively lock the telescopic member 54 and the bracket 58 relative to one another. The lock 308 is supported by the vertical support member 50 and is configured to engage complementary locking features (not shown) on each of the telescopic member 54 and the bracket 58. The lock 308 is configured to not allow downward motion of the bracket 58 relative to the telescopic member 54 and the telescopic member 54 relative to the vertical support member 50 while the telescopic member 54 and the bracket 58 are moving between positions and once the telescopic member 54 and the bracket 58 are stopped in each position. The lock 308 is configured as a safety mechanism that prevents the telescopic member 54 and the bracket 58 from collapsing downward should the hydraulic pump 300 or hydraulic cylinder 30 fail. The lock 308 must be released to move the hydraulic cylinder 30 to a lower position.

In the first position, a height between the first end 250 and the second end 254 of the hydraulic cylinder 30 is H2 (FIG. 8). In the illustrated embodiment, H1 and H2 are less than 9 feet. In the first position, the second end 254 of the piston 256 is at or adjacent to the second end of the first cylinder 258a, the second end of the first cylinder 258a is at or adjacent to the second end of the second cylinder 258b, and the second end of the second cylinder 258b is at or adjacent to the second end of the third cylinder 258c. When the hydraulic cylinder 30 is in the first position, the vertical support assembly 18 is in a contracted position. That is, the first end 130 of the telescopic member 54 is at or adjacent to the first end 120 of the vertical support member 50 and the second end 134 of the telescopic member 54 is at or adjacent to the second end 124 of the vertical support member 50. Additionally, the bracket 58 is in a first position in which a bottom surface is at or adjacent to the first end 130 of the telescopic member 54 and is adjacent to or contacting the base 14 such that the platform 80 is in the loading position. In the contracted position, the maximum height of the lift 10 is defined by the height H1 of the vertical support member 50. As noted above, H1 measures 9 feet or less. In the illustrated embodiment, H1 measures 8 feet. When the lift 10 is being transported, the vertical support assembly 18 is in the contracted position and the platform 80 (and optionally the arm 70) is disassembled from the vertical support assembly 18. When the vertical support assembly 18 is assembled with the arm 70 and platform 80 after delivery, the platform 80 is in the loading position when the vertical support assembly 18 is in the contracted position.

In the second position, a height between the first end 250 and the second end 254 of the telescopic hydraulic cylinder 30 is H3 (FIG. 10), which is greater than H2. In the illustrated embodiment, H3 is greater than 9 feet. In the second position, the second end 254 of the piston 256 is at or adjacent to the first end of the first cylinder 258a, the second end of the first cylinder 258a is at or adjacent to the first end of the second cylinder 258b, and the second end of the second cylinder 258b is at or adjacent to the first end of the third cylinder 258c. Also, in the illustrated embodiment, the second end 254 of the hydraulic cylinder 30 extends from the telescopic member 54 in the second position. In other embodiments, the second end 254 may be at or below the second end 134 of the telescopic member 54 in the second position. When the hydraulic cylinder 30 is in the second position, the vertical support assembly 18 is in an extended position. That is, the first end 130 of the telescopic member 54 is spaced apart from the first end 120 of the vertical support member 50, and the second end 134 of the telescopic member 54 is spaced apart from the second end 124 of the vertical support member 50. Additionally, the bracket 58 is in a second position in which the bottom surface is spaced apart from a first end 130 of the telescopic member 54 and spaced apart from the base 14 such that the platform 80 is in the storage position. In the extended position, a maximum height of the lift 10 is H4 and may be defined between the first end 120 of the vertical support member 50 and a second end 134 of the telescopic member 54. In other embodiments, a maximum height of the lift 10 may defined by the height H3 of the hydraulic cylinder in the second position. Regardless, preferably, the maximum height of the lift 10 in the extended position is greater than 9 feet.

Although not illustrated, the hydraulic cylinder 30 may be movable from either the first position or the second position to one or more intermediate positions. In the intermediate positions, a height between the first end 250 and the second end 254 of the hydraulic cylinder 30 is greater than H2 and less than H3. In the intermediate positions, piston 256 and cylinders 258a-258c may be positioned relative to one another to effectuate the intermediate height of the hydraulic cylinder 30. When the telescopic member 54 and the bracket 58 are positioned in one or more intermediate positions corresponding to one or more intermediate positions of the hydraulic cylinder 30, the vertical support assembly 18 is in one of the intermediate positions. In the intermediate positions, the maximum height of the lift 10 is between Hl and H4 in the one or more intermediate positions. The platform 80 is in one of the intermediate positions when the vertical support assembly 18 is in one of the intermediate positions. The intermediate positions of the platform 80 may also be storage positions.

In other embodiments, the telescopic member 54 may be a first telescopic member and the lift 10 may further include a second telescopic member. In such case, the second telescopic member may be movably coupled to the first telescopic member 54 in a similar manner that the first telescopic member 54 is coupled to the vertical support member 50, as discussed above. The bracket 58 may be movably coupled to the second telescopic member in a similar manner as the bracket 58 is movably coupled to the telescopic member 54, as discussed above. The second telescopic member may be included to further increase the maximum height of the lift 10.

The lift 10 is sized and shaped to be transported to a lift operator such that little assembly is required once delivered. The vertical support assembly 18 may be transported in the contracted position (FIGS. 6-8). To that end, the lift 10 has a transport position in which the vertical support assembly 18 in the contracted position, the platform 80 is disassembled from the arm 70, and the first and second extensions 108 are disassembled, folded or contracted from the respective horizontal support members 22a, 22b. Additionally, the platform 80 may be disassembled or in the contracted position when in the transport position. That is, the first, second, and third telescopic support members 204a, 204b, 220 may be disassembled from the central support member 200. Importantly, in the transport position, the telescopic member 54 is pre-assembled to the vertical support member 50, the bracket 58 is pre-assembled to the telescopic member 54, and the hydraulic cylinder 30 is pre-assembled to the base 14 and bracket 58. When applicable, the horizontal support members 22a, 22b may be pivoted towards one another to further reduce the footprint of the lift 10. In the transport position, the lift 10 is therefore configured to fit in the trailer of a semi-truck for transport since the maximum height of the vertical support assembly 18 in the contracted position is 9 feet or less.

Once the lift 10 arrives at its destination, the assembly required to assemble the lift 10 is minimal. That is, the extensions 108 are coupled to the respective horizontal support members 22a, 22b and the platform 80 is coupled to the arm 70. Also, the coupling face 216 of the central support member 200 of the platform 80 may be coupled to the second coupling face 192 of the arm 70. If disassembled, the platform 80 can be assembled by coupling the first, second, and third telescopic support members 258a-258c to the central support member 200. The assembly is minimal because the configurations discussed herein avoids the need for rigging for assembly using heavy equipment (e.g., fork trucks, lifts, cranes, etc.) and the need for skilled heavy machinery assemblers (e.g., riggers, millwrights, mechanics, etc.) at the operator's location since the major components (e.g., the base 14, 414, the vertical support assembly 18, 418, the first horizontal support member 22a, 422a, the second horizontal support member 22b, 422b, and the hydraulic cylinder 30, 430, etc.) are all pre-assembled.

Initially, after assembly, the vertical support assembly 18 is in the contracted position and the platform 80 is in the loading position. Once the airplane is loaded onto the platform 80, the operator can actuate the first actuator 304a to move the vertical support assembly 18 to the extended position or one of the plurality of positions such that the platform 80 is in the corresponding storage or intermediate position as well. To lower the platform 80, the operator can hold the safety release mechanism actuator (described but not shown) and actuate the second actuator 304b to move the platform down to one of the intermediate positions or to the contracted position.

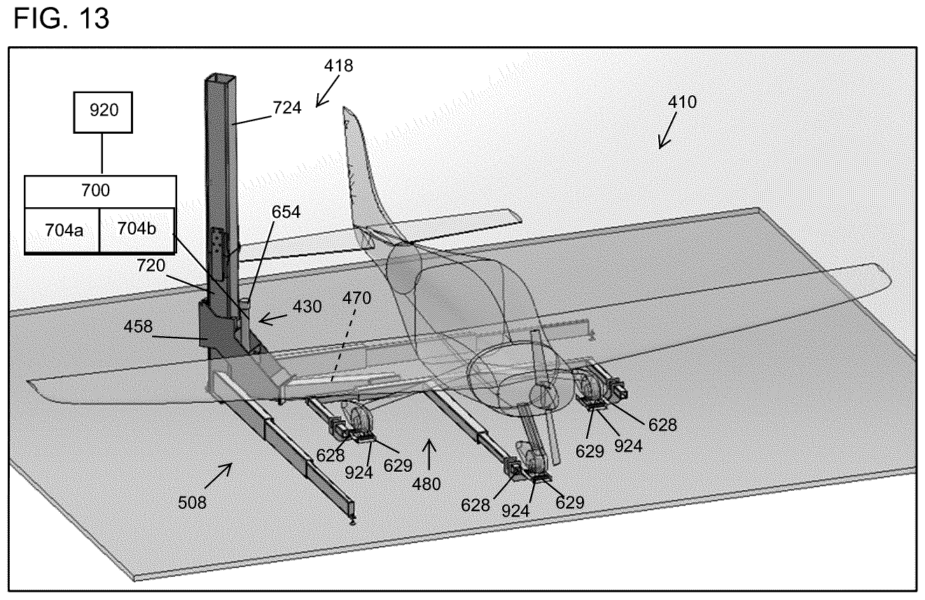

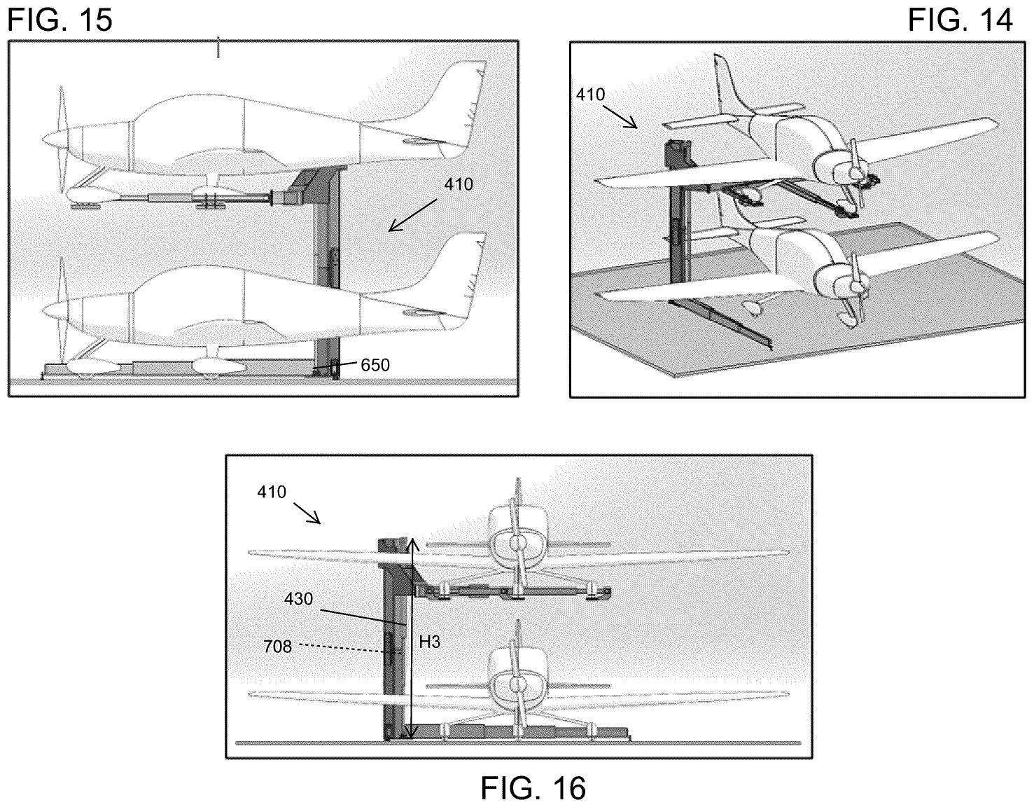

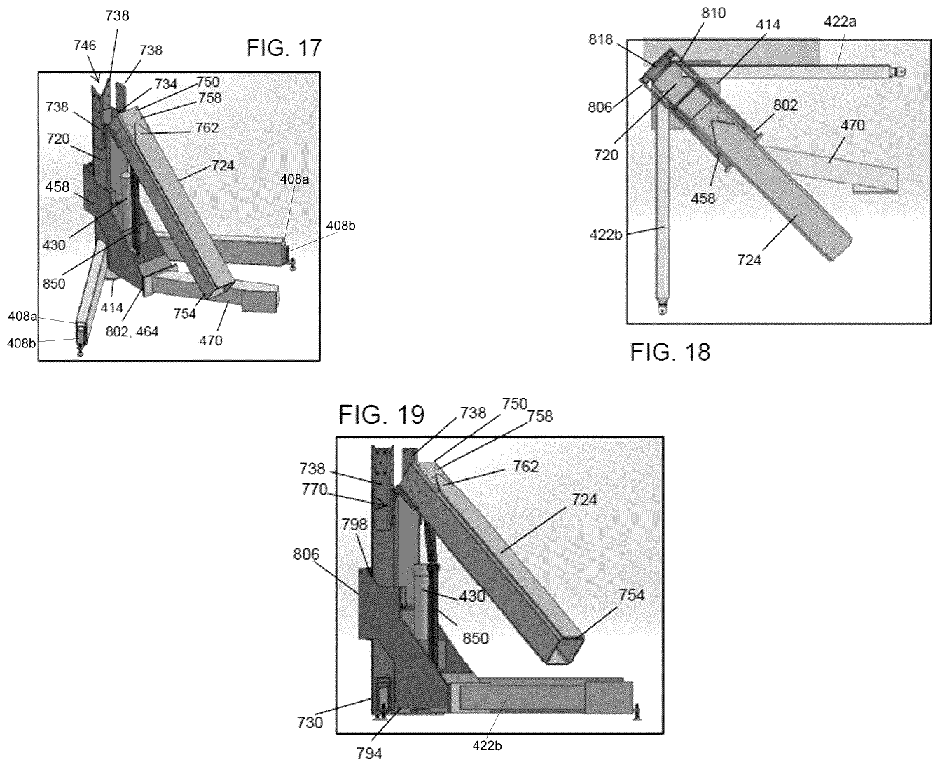

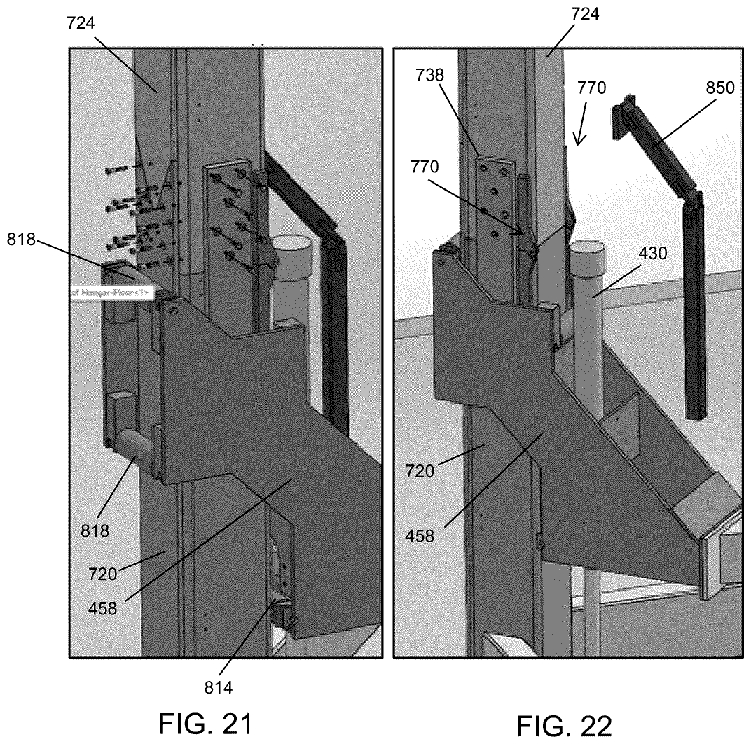

FIGS. 13-22 illustrate another embodiment for a lift 410 according to another embodiment. The lift 410 of the FIGS. 13-22 is similar to the lift 10. Therefore, like structure will be identified with like reference numerals plus “400” and only the differences will be discussed herein. The vertical support assembly 418 includes a first vertical support member 720 supported by the base 414, a second vertical support member 724 pivotably coupled to the first vertical support member 720, and a bracket 458 movably coupled to both the first vertical support member 720 and the second vertical support member 724. Thus, the second vertical support member 724 is pivotable relative to the first vertical support member 724 to move the vertical support assembly between the contracted position (FIG. 17-20) and the extended position (FIGS. 13-16 and 20).

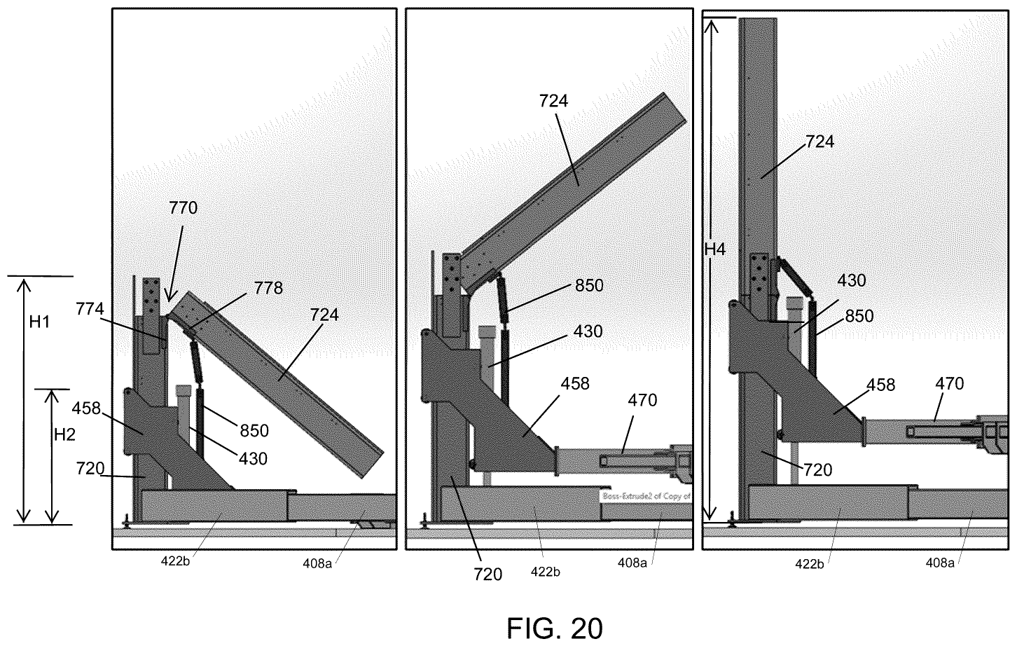

With respect to FIGS. 17 and 19, the first vertical support member 720 includes a first end 730 coupled to the base 414 and a second end 734 opposite the first end 730. The first vertical support member 720 also includes a plurality of couplers 738 coupled to and extending from the second end 734. Thus, distal ends of the couplers 738 are spaced apart from the second end 734 of the first vertical support member 720. In the illustrated embodiment there are three couplers 738, one on each of three walls of the first vertical support member 720. The coupler 738 (e.g., the rear coupler 738) coupled to a rear wall of the first vertical support member 720 includes a recess 746 extending from the distal end towards the second end 734 of the first vertical support member 720. In the illustrated embodiment, the V-shaped recess. In other embodiments, there may be more or fewer couplers. The first vertical support member 720 includes a first height H1 (FIG. 20) that is less than or equal to 9 feet. The height H1 is measured from the first end 730 of the first vertical support member 720 to the distal end of the rear coupler 738.

Further with respect to FIGS. 17 and 19, the second vertical support member 724 includes a first end 750 and a second end 754 opposite the first end 750. The second vertical support member 724 also includes a groove 758 in a rear wall thereof. The groove 758 is positioned adjacent the first end 750. In the illustrated embodiment, because of the groove 758, the rear wall thus includes V-shaped contour 762. The groove 758 is configured to receive the rear coupler 738 in a mating relationship. That is, the groove 758 is sized and shaped to receive the rear coupler 78 such that a rear surface of the rear wall of the first vertical support member 720 is flush with a rear surface of the rear wall of the second vertical support member 724 when the vertical support assembly 418 is in the extended position. That is, when the rear coupler 738 is received within the groove 758, the recess 746 of the rear coupler 738 is configured to receive the V-shaped contour 762 of the rear wall of the second vertical support member 724. In other embodiments, the recess 746 and the contour 762 may include any suitable size and shape or the recess and groove may not be present. The second vertical support member 724 includes the same cross-sectional size and shape as the first vertical support member 720 such that when in the extended position, the second vertical support member 724 is supported by and aligned with the first vertical support member 728.

The second vertical support member 724 is pivotably coupled to the first vertical support member 720 via a pair of hinges 770. Each of the pair of hinges includes a first leg 774 and a second leg 778 pivotably coupled to the first leg 774. For each of the pair of hinges 770, the first leg 774 is coupled one of the side walls of the first vertical support member 720 and the second leg 778 is coupled to one of the side walls of the second vertical support member 724.

The bracket 458 is movably coupled to the both the first vertical support member 720 and second vertical support member 724. In the illustrated embodiment, the bracket 458 includes a body including a first end 794, a second end 798 opposite the first end 794, a front end 802, and a rear end 806 opposite the front end 802. The coupling face 464 is positioned at the front end 802 and, as discussed above, is configured to couple the platform 480, which has the same features as those shown and described relative to the embodiment of FIGS. 1-12. An aperture 810 is positioned between the front end 802 and the rear end 806 and extends through the body between the first end 794 and the second end 798. The aperture 810 is positioned closer to the rear end 806 than the front end 802. The aperture 810 is sized and shaped to receive the first vertical support member 720 and second vertical support member 724. Thus, the rear end 806 is positioned adjacent the rear walls of the first vertical support member 720 and second vertical support member 724. A first pair of rollers 814 is supported between the front end 802 and the rear end 806, and a second pair of rollers 818 is supported at the rear end 806. The first pair of rollers 814 is configured to contact and move along the front walls of the first and second vertical support members 720, 724. The second pair of rollers 818 is configured to contact and move along the rear walls of the first and second vertical support members 720, 724. The hydraulic cylinder 430 is coupled to the bracket 458, such that the bracket 458 is movable with the hydraulic cylinder 430.

In the illustrated embodiment, a linkage 850 may be coupled between the second vertical support member 724 and the bracket 458 in the contracted position. The linkage 850 is intended to maintain the vertical support assembly 418 in the contracted position during transport. The linkage 850 is also configured to enable the vertical support assembly 418 to move from the contracted position to the extended position, as will be discussed in greater detail below. The linkage 850 is removable from both the second vertical support member 724 and the bracket 748 once the vertical support assembly 418 is in the extended position and prior to use.

In the embodiment of FIGS. 13-22, the vertical support assembly 418 may be transported in the contracted position (FIGS. 17-19). That is, the second vertical support member 724 is positioned at oblique angle (e.g., an acute angle) relative to the first vertical support member 720, such that the total height of the lift is equal to H1. As discussed above, H1 is less than or equal to 9 feet. Moreover, as shown, the vertical support assembly 418 is also contained within a perimeter defined by the horizontal support members 422a, 422b. Accordingly, the base 414, the vertical support assembly 418, the arm 470, the first horizontal support member 422a, the second horizontal support member 422b, and the hydraulic cylinder 430 collectively may be contained within a volume equal to or less than a volume of 720 ft³. Once at the destination and in use, the vertical support assembly 418 is moved to and remains in the extended position. That is, the second vertical support member 724 is supported by and aligned with first vertical support member 720 through the use of the couplers 738, such that the total height of the lift is equal to the H3 (e.g., in this case the total height of the hydraulic cylinder 430, FIG. 16) and the total height of the vertical support assembly 418 is equal to H4 (FIG. 20). In other embodiments, the total height of the lift may be equal to the height H4 of the vertical support assembly 418.

When the hydraulic cylinder 430 is in the first position, the bracket 458 is in a first position in which a bottom surface at the first end 794 is at or adjacent to the first end 730 of the first vertical support member 720 and is adjacent to or contacting the base 414 such that the platform 480 is in the loading position. When the hydraulic cylinder 430 is in the second position (at a height that is about H3), the bracket 458 is in a second position in which the bottom surface at the first end 794 is spaced apart from the first end 730 of the first vertical support member and the base and positioned at or adjacent to the second end 754 of the second verticals support member 724. Accordingly, the platform 480 is in the storage position when the hydraulic cylinder 430 is in the second position.

Although not illustrated, the hydraulic cylinder 430 may be movable from either the first position or the second position to one or more intermediate positions. In the intermediate positions, a height between the first end 650 and the second end 654 of the hydraulic cylinder 430 is greater than H2 and less than H3. When the hydraulic cylinder 430 is positioned in one or more intermediate positions, the bracket 458 is also positioned in one or more intermediate positions of the hydraulic cylinder 430, which may be less than height of the platform 480 in the extended position and greater than the height of the platform in the loading position. The platform 480 is in one of the intermediate positions when the bracket 458 is in one of the intermediate positions. The intermediate positions of the platform 480 may also be storage positions.

Like the lift 10, the lift 410 is sized and shaped to be transported to a lift operator such that little assembly is required once delivered. To that end, the lift 410 has a transport position in which the vertical support assembly 418 in the contracted position, the platform 480 is disassembled from the arm 470, and the first and second extensions 508 are disassembled, folded or contracted from the respective horizontal support members 422a, 422b. Additionally, the platform 480 may be disassembled or in the contracted position when in the transport position, as discussed above with respect to FIGS. 1-12. Importantly, in the transport position, the first vertical support member 720 is pre-assembled to the base 414 and the bracket 458, the second vertical support member 724 is pre-assembled to the first vertical support member 720, the bracket 458 is pre-assembled to the first vertical support member 720, and the hydraulic cylinder 430 is pre-assembled to the base 414 and the bracket 458. When applicable, the horizontal support members 422a, 422b may be pivoted towards one another to further reduce the footprint (e.g., perimeter) of the lift 410. In the transport position, the lift 410 is therefore configured to fit in the trailer of a semi-truck for transport since the maximum height of the vertical support assembly 418 in the contracted position is 9 feet or less.

Once the lift 410 arrives at its destination, the assembly required to assemble the lift 410 is minimal. The assembly is minimal because the configurations discussed herein avoids the need for rigging for assembly using heavy equipment (e.g., fork trucks, lifts, cranes, etc.) and the need for skilled heavy machinery assemblers (e.g., riggers, millwrights, mechanics, etc.) at the operator's location since the major components (e.g., the base 14, 414, the vertical support assembly 18, 418, the first horizontal support member 22a, 422a, the second horizontal support member 22b, 422b, and the hydraulic cylinder 30, 430, etc.) are all pre-assembled. If applicable the horizontal support members 422a, 422b are pivoted outwardly. The extensions 508 are coupled to the respective horizontal support members 422a, 422b and the platform 480 is coupled to the arm 470, as discussed above with respect to FIGS. 1-12. If disassembled, the platform 480 can be assembled, as discussed above, as well. The second vertical support member 724 is pivotable (via the hinges 770) relative to the first vertical support member 720 from the contracted position to the extended position. More specifically, with the linkage 850 coupled between the second vertical support member 724 and the bracket 758 and the wheel chocks 229 secured to the wheel support members 228 (discussed in greater detail below), the hydraulic cylinder 430 is actuated to move from the first position to the second position. As they hydraulic cylinder 430 moves from the first position to the second position, the linkage 850 exerts a force on the second vertical support member 724 to pivot the second vertical support member 724 relative to the first vertical support member 720 and into the extended position. When in the extended position (with the linkage 850 still attached), fasteners (e.g., bolts) are inserted into aligned apertures in the couplers 738 and second vertical support members 720, 724 to secure the second vertical support member 724 to the first vertical support member 720. The linkage 850 is then removed before the lift is used. The linkage 850 can be reattached to move the vertical support assembly 418 from the extended position back to the contracted position.

Initially, after assembly, the vertical support assembly 418 is in the extended position and the platform 480 is in the loading position. Once the airplane is loaded onto the platform 480, the operator can actuate the first actuator 704a to move the vertical support assembly 418 to the extended position or one of the plurality of positions such that the platform 480 is in the corresponding storage or intermediate position as well. To lower the platform 480, the operator can hold the safety release mechanism actuator (described but not shown) and actuate the second actuator 704b to move the platform down to one of the intermediate positions or to the contracted position.

In either embodiment, an electronic control unit 920 may be in electrical communication with the hydraulic pump 300, 700. Additionally, a switch or sensor 924 may be associated with each of the wheel support members 228, 628, and in particular, the wheel chocks 229, 629 (e.g., wheel restraints). The sensors 924 are in electrical communication with the electronic control unit 920. Therefore, each of the sensors 924 may be configured to detect that the respective wheel chocks 629 are positioned and secured properly on the wheel support member 228, 628. For each sensor 924, when the sensor 924 detects that the respective wheel chock 229, 629 is positioned and secured properly on the wheel support member 228, 628, the sensor 924 is configured to send a signal to electronic control unit 920. When the electronic control unit 920 receives the signals from each of the sensors 924, the electronic control unit 920 is configured to allow the hydraulic pump 300, 700 to actuate the hydraulic cylinder 30, 430 when the first actuator 304a, 704a is actuated. If the electronic control unit 920 does not receive a signal from all sensors 924, then the electronic control unit 920 is configured to prevent the hydraulic pump 300, 700 from actuating the hydraulic cylinder 30, 430 when the first actuator 304a, 704a is actuated. In other words, the electronic control unit 920 is configured to prevent the hydraulic pump from actuating the hydraulic cylinder when the actuator is actuated when the sensor of at least one of the plurality of wheel supports does not send the signal to electronic control unit. This prevents the platform 80, 480 from being raised without the wheel chocks being appropriately secured thereto. In another embodiment, a bracket (e.g., a nose wheel securing bracket or a wheel restraint) may couple the nose wheel of the airplane to the wheel support member 228, 628 such that the wheel could not move relative to the wheel support member 228, 628. Airplane nose wheels have connection points for attaching towing bars, so this embodiment would use these connection points such that the bracket would secure the nose wheel to the wheel support member 228, 628. When the bracket is properly installed it would use an electronic sensor 924 configured to send a signal to the control unit 920 allowing the hydraulic pump 300, 700 to actuate the hydraulic cylinder 30, 430 when the first actuator 304a, 704a is actuated.

Although the drive mechanisms 30, 430 each include hydraulic cylinders that are movable via a hydraulic pump 300, 700 in the illustrated embodiments, in other embodiments, the drive mechanisms 30, 430 may include other suitable means of moving the vertical support assembly between the contracted, extended and intermediate positions. For example, the drive mechanisms 30, 430 could be a manual or motorized chain hoist, cable hoist, strap hoist, pulley mechanism, or other suitable mechanism.

Although the invention has been described in detail with reference to certain preferred embodiments, variations and modifications exist within the scope and spirit of one or more independent aspects of the invention as described.

Various features of the invention are set forth in the following claims.

What is claimed is:

1. An airplane lift comprising:
a base configured to be supported on a support surface;
a vertical support assembly coupled to the base, the vertical support assembly movable between a contracted position and an extended position;
a platform removably couplable to the vertical support assembly and configured to support an airplane; and
a drive mechanism supported by the base and configured to move the platform between a loading position and a storage position,
wherein a maximum height of the vertical support assembly is less than or equal to 9 feet when in the contracted position, such that the airplane lift may be transported with the vertical support assembly pre-assembled and in the contracted position.

2. The airplane lift of claim 1, wherein the vertical support assembly includes:
a first vertical support member coupled to the base;
a second vertical support member pivotably coupled to the first vertical support member by a hinge, the second vertical support member positioned at an oblique angle relative to the first vertical support member in the contracted position and the second vertical support member supported by and aligned with the first vertical support member in the extended position; and
a bracket movable relative to the first vertical support member and the second vertical support member when the vertical support assembly is in the extended position.

3. The airplane lift of claim 2, wherein the drive mechanism is coupled to the bracket such that the bracket is movable with the drive mechanism.

4. The airplane lift of claim 2, further comprising an arm removably coupled to the bracket in a first orientation or a second orientation, and wherein the platform is removably coupled to the arm.

5. The airplane lift of claim 1, further comprising a first horizontal member and a second horizontal member, each coupled to and extending from the base, each of the first horizontal member and the second horizontal member having a length that is less than or equal to 8 feet, such that the first horizontal member and the second horizontal member may be transported pre-assembled with the base and the vertical support assembly.

6. The airplane lift of claim 5, wherein the base, the vertical support assembly, the drive mechanism, the first horizontal member, and the second horizontal member are pre-assembled into a transport position that collectively may be contained within a volume equal to or less than 720 ft³.

7. The airplane lift of claim 1, wherein the drive mechanism is a hydraulic cylinder moveable by a hydraulic pump.

8. The airplane lift of claim 1, wherein the vertical support assembly includes:
a vertical support member supported by the base;
a telescopic member movably coupled to the vertical support member; and
a bracket movably coupled to the telescopic member.

9. An airplane lift comprising:
a base configured to be supported on a support surface;
a drive mechanism supported by the base;
a first vertical support member supported by the base;
a second vertical support member pivotably coupled to the first vertical support member;
a bracket fixedly coupled to the drive mechanism; and
a platform removably couplable to the bracket and configured to support an airplane,
wherein in a contracted position, the second vertical support member is positioned at an oblique angle relative to the first vertical support member, such that the first vertical support member defines a maximum height of the airplane lift that is 9 feet or less,
wherein the airplane lift may be transported with the second vertical support member pre-assembled with the first vertical support member and in the contracted position,
wherein in an extended position, the second vertical support member is supported by and aligned with the first vertical support member such that the first vertical support member and the second vertical support member collectively define a maximum height of the airplane lift that is greater than 9 feet, and
wherein in the extended position, the bracket is movable along the first vertical support member and the second vertical support member to move the platform between a loading position and a storage position.

10. The airplane lift of claim 9, wherein the base, the first vertical support member, the second vertical support member, the bracket, and the drive mechanism are pre-assembled into a transport position that collectively may be contained within a volume equal to or less than 720 ft³.

11. The airplane lift of claim 9, further comprising a linkage removably coupled between the second vertical support member and the bracket, and wherein the linkage, with the drive mechanism, configured to pivot the second vertical support member relative to the first vertical support member to move the second vertical support member between the contracted position and the extended position.

12. The airplane lift of claim 9, wherein the platform includes a wheel support for supporting a wheel of the airplane, the wheel support includes a wheel chock and a sensor associated with the wheel chock, and further comprising an electronic control unit in electrical communication with an actuator of the drive mechanism and the sensor of the wheel support, wherein the sensor is configured to send a signal to the electronic control unit when the wheel chock is secured to the wheel support, and wherein the electronic control unit is configured to
allow the drive mechanism to be actuated when the actuator is actuated when the sensor of the wheel support sends the signal to the electronic control unit, and
prevent the drive mechanism from being actuated when the actuator is actuated when the sensor of the wheel support does not send the signal to the electronic control unit.

13. The airplane lift of claim 9, further comprising a first horizontal member and a second horizontal member, each coupled to and extending from the base, each of the first horizontal member and the second horizontal member having a length that is less than or equal to 8 feet, such that the first horizontal member and the second horizontal member may be transported pre-assembled with the base and the first vertical support member and the second vertical support member.

14. The airplane lift of claim 13, wherein the base, the first vertical support member, the second vertical support member, the bracket, the drive mechanism, the first horizontal member, and the second horizontal member are pre-assembled into a transport position that collectively may be contained within a volume equal to or less than 720 ft³.

15. The airplane lift of claim 9, wherein the drive mechanism is a hydraulic cylinder moveable by a hydraulic pump.

16. The airplane lift of claim 9, further comprising an arm removably coupled to the bracket in a first orientation or a second orientation, and wherein the platform is removably coupled to the arm.

17. An airplane lift comprising:
a base configured to be supported on a support surface;
a vertical support assembly supported by the base, the vertical support assembly movable between a contracted position and an extended position;
a platform removably couplable to the vertical support assembly and including at least one wheel support configured to support an airplane, the at least one wheel support including a wheel restraint and a sensor associated with the wheel restraint;
a drive mechanism supported by the base and configured to move the platform between a loading position and a storage position;
an electronic control unit in electrical communication with an actuator of the drive mechanism and the sensor of the at least one wheel support;
wherein a height of the vertical support assembly is less than or equal to 9 feet when in the contracted position, such that the airplane lift may be transported already assembled in the contracted position,
wherein the sensor of the at least one wheel support is configured to send a signal to the electronic control unit when the wheel restraint is secured to the wheel support, and wherein the electronic control unit is configured to
allow the drive mechanism to be actuated when the actuator is actuated when the sensor of the at least one wheel support sends the signal to electronic control unit, and
prevent the drive mechanism from being actuated when the actuator is actuated when the sensor of the at least one wheel support does not send the signal to electronic control unit.

18. The airplane lift of claim 17, further comprising a first horizontal member and a second horizontal member, each coupled to and extending from the base, each of the first horizontal member and the second horizontal member having a length that is less than or equal to 8 feet, such that the first horizontal member and the second horizontal member may be transported pre-assembled with the vertical support assembly.

19. The airplane lift of claim 17, wherein the wheel restraint is a wheel chock couplable to the at least one wheel support.

20. The airplane lift of claim 17, wherein the wheel restraint is a nose wheel securing bracket couplable between a nose wheel of the airplane and the at least one wheel support.
